(19) United States
(12) Patent Application Publication
(10) Pub. No.: US 2026/0021013 A1
(43) Pub. Date: Jan. 22, 2026

(54) MOUNTING STRUCTURE CAPABLE OF ADAPTING TO MULTIPLE MASSAGE HEADS

(71) Applicant: Zhejiang Red And Black Technology Co., Ltd., Lishui (CN)

(72) Inventors: Xinyi Shu, Jinyun (CN); Lifeng Shu, Jinyun (CN)

(21) Appl. No.: 18/822,118

(22) Filed: Aug. 31, 2024

(30) Foreign Application Priority Data
Jul. 18, 2024 (CN) 202421721758X

(51) Int. Cl. A61H 15/00

(52) U.S. Cl. CPC A61H 15/00; A61H 2201/0107

(57) ABSTRACT

A mounting structure capable of adapting to multiple massage heads includes a sliding rod and a mounting seat. A center of the sliding rod is a hollow limiting groove, and an edge end of the sliding rod is provided with a first positioning hole. A limiting member abutting against an edge of the limiting groove is arranged at a center of the mounting seat, and the limiting member is provided with a second positioning hole. A limiting column adapted to the limiting groove is arranged at a center of the limiting member, and the mounting seat is further provided with a plurality of buckling holes. The massage head is provided with buckles with the same number as that of the buckling holes. Through the connection between the massage head and the mounting seat, the massage head can be made smaller in dimension during design, reducing required materials and costs.

### TECHNICAL FIELD

The present disclosure relates to the field of massage devices, and in particular, to a mounting structure capable of adapting to multiple massage heads.

### BACKGROUND

With the improvement of living standards, people begin to pay attention to health preservation, and massage devices accordingly develop.

In an existing massage device market, a mounting structure of a massage head is often connected to a device body by using an integrated design or a complex fixing mechanism. This design method has many disadvantages. Firstly, this limits design diversity of the massage head. In order to adapt to a specific mounting structure, massage heads are often designed in larger dimensions, which increases manufacturing costs. Secondly, large-dimensional massage heads need more raw materials during production, directly leading to an increase in costs. In addition, packaging material consumption also increases, further increasing overall costs. Furthermore, the large-dimensional massage head and packaging thereof occupy a large space, which causes inconvenience to transportation and storage of products, and increases transportation costs and storage difficulty. In addition, when the massage head is damaged, the large-dimensional massage head is higher in cost. This not only increases the economic burden of users, but also wastes resources.

### SUMMARY

In view of the above situation, it is necessary to provide a mounting structure capable of adapting to multiple massage heads to solve at least one of the above problems. The mounting structure includes a sliding rod and a mounting seat, where a center of the sliding rod is a hollow limiting groove, an edge end of the sliding rod is provided with a first positioning hole, a limiting member abutting against an edge of the limiting groove is arranged at a center of the mounting seat, the limiting member is provided with a second positioning hole, a limiting column adapted to the limiting groove is arranged at a center of the limiting member, the mounting seat is further provided with a plurality of buckling holes, and the massage head is provided with buckles with the same number as that of the buckling holes.

Preferably, the second positioning hole includes a first hole slot and a second hole slot, the first hole slot is provided at one end of the mounting seat, the second hole slot is provided in the first hole slot and penetrates to the other end of the mounting seat, and the second hole slot has a diameter less than that of the first hole slot.

Preferably, the buckle includes a buckle body and a connecting rod, one end of the connecting rod is fixedly arranged on the massage head, the buckle body is a cone, and a bottom surface of the buckle body is fixedly connected to the other end of the connecting rod.

Preferably, an edge of the mounting seat is further provided with a circle of limiting edge, and the limiting edge protrudes relative to a plane of the mounting seat.

Preferably, the massage head is further provided with a limiting portion, and the limiting portion fits with the limiting edge.

Preferably, the sliding rod is further provided with a wire hole.

Preferably, the buckle is made of an elastic material.

Preferably, the mounting seat is provided with a Velcro hook side, and the massage head is provided with a Velcro loop side.

### BRIEF DESCRIPTION OF THE DRAWINGS

1. Sliding rod; 11. Limiting groove; 12. First positioning hole; 13. Wire hole; 2. Mounting seat; 21. Limiting member; 211. Limiting column; 212. Second positioning hole; 2221. First hole slot; 2222. Second hole slot; 22. Buckling hole; 23. Buckle; 231. Buckle body; 232. Connecting rod; 24. Limiting edge; 3. Massage head; 31. Limiting portion.

FIG. 1 is a schematic diagram of a connecting structure of a massage head, a mounting seat and a sliding rod according to an embodiment of the present disclosure;

FIG. 2 is an exploded view of a massage head, a mounting seat and a sliding rod according to an embodiment of the present disclosure;

FIG. 3 is a schematic structural diagram of a mounting seat according to an embodiment of the present disclosure;

FIG. 4 is a sectional view of a mounting seat according to an embodiment of the present disclosure;

FIG. 5 is a schematic structural diagram of two different types of massage heads according to an embodiment of the present disclosure; and

FIG. 6 is a schematic structural diagram of a sliding rod according to an embodiment of the present disclosure.

### DETAILED DESCRIPTION OF THE EMBODIMENTS

In order to make the objective, technical solutions, and advantages of the present disclosure clearer, a mounting structure capable of adapting to multiple massage heads according to the present disclosure is described in further detail below with reference to the accompanying drawings and embodiments. It should be understood that specific embodiments described herein are merely intended to explain the present disclosure, but are not intended to limit the present disclosure.

In the description of the present disclosure, unless otherwise specified, “a plurality of” means two or more. The directional or positional relationship indicated by the term such as “central”, “longitudinal”, “transverse”, “upper”, “lower”, “left”, “right”, “inside”, “outside”, “front end”, “rear end”, “head”, “tail”, “vertical”, “horizontal”, “top”, and “bottom” is the directional or positional relationship based on the accompanying drawings, and is merely intended to facilitate and simplify the description of the present disclosure, rather than to indicate or imply that the device or element referred to must have a particular direction and be constructed and operated in a particular direction. Therefore, this should not be construed as limiting the present disclosure. Moreover, the terms “first”, “second”, and “third” are merely used for description, and are not intended to indicate or imply relative importance.

In the description of the present disclosure, it should be noted that, unless otherwise clearly specified, meanings of terms “mount”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

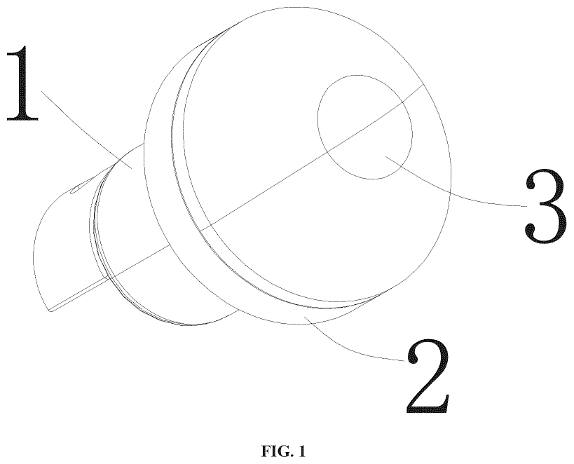

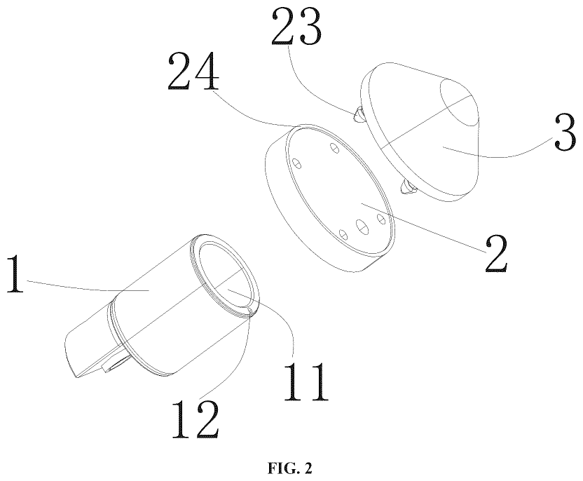

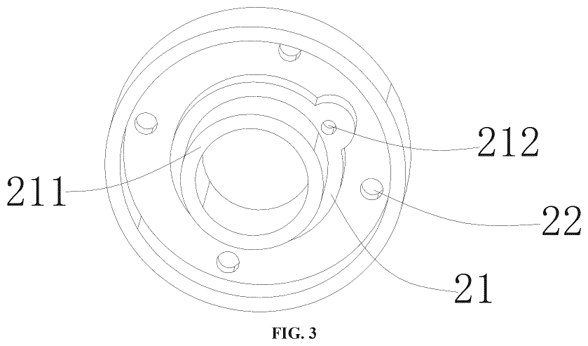

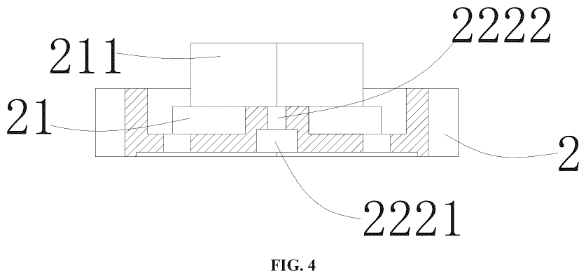

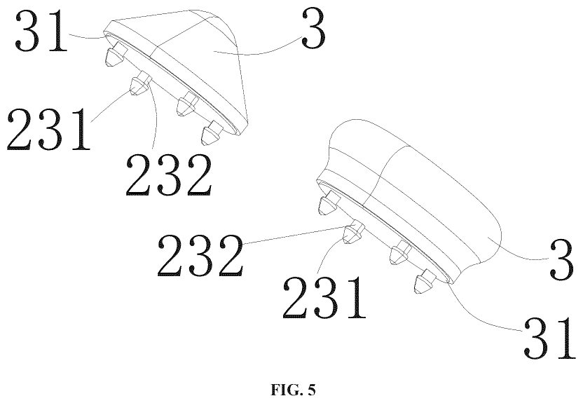

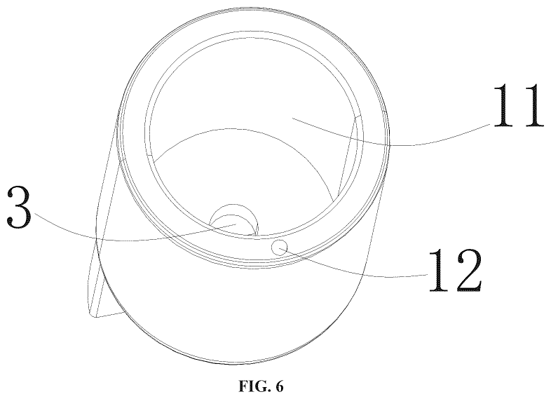

Referring to FIGS. 1 to 6, a mounting structure capable of adapting to multiple massage heads 3 according to an embodiment of the present disclosure includes a sliding rod 1 and a mounting seat 2. A center of the sliding rod 1 is a hollow limiting groove 11, and an edge end of the sliding rod 1 is provided with first positioning holes 12. A limiting member 21 abutting against an edge of the limiting groove 11 is arranged at a center of the mounting seat 2, and the limiting member 21 is provided with a second positioning hole 212. A limiting column 211 adapted to the limiting groove 11 is arranged at a center of the limiting member 21, and the mounting seat 2 is further provided with a plurality of buckling holes 22. The massage head 3 is provided with buckles 23 with the same number as that of the buckling holes 22.

In the above embodiment, the sliding rod 1 is used as a basic component for supporting and guiding, and a central part thereof is designed as the hollow limiting groove 11. This design not only reduces the overall weight, but also provides an accurate sliding and positioning space for the mounting seat 2. The first positioning holes 12 are distributed at the edge end of the sliding rod 1. These holes are used for preliminary positioning or fixed connection to other assemblies during subsequent mounting to ensure stability of the structure. The mounting seat 2 is a key part for connecting the massage head 3, and the limiting member 21 arranged at the center of the mounting seat closely abuts against the edge of the limiting groove 11 of the sliding rod 1, thereby forming preliminary axial positioning. The second positioning hole 212 provided in the limiting member 21 corresponds to the first positioning hole 12 in the sliding rod 1, and the positions of the two positioning holes can be further locked by pins or other fasteners to prevent relative movement. More importantly, the limiting column 211 arranged at the center of the limiting member 21 perfectly matches the limiting groove 11 of the sliding rod 1 in dimension and shape, and is inserted into the limiting groove 11 to implement stable sliding and accurate positioning of the mounting seat 2 on the sliding rod 1. In addition, the mounting seat 2 is further provided with the plurality of buckling holes 22, which are in a one-to-one correspondence with the buckles 23 on the massage head 3 to be mounted. A corresponding number of buckles 23 are arranged at a bottom of the massage head 3, and these buckles 23 can be accurately inserted into the buckling holes 22 of the mounting seat 2 during mounting, so that quick connection and locking between the massage head 3 and the mounting seat 2 can be implemented through a simple pressing operation without a complicated tool or complicated steps.

To sum up, the massage head 3 can be made smaller in dimension, which effectively reduces a required material and further reduces costs. In addition, the short massage head 3 means that a smaller box can be used during packaging, which improves transportation efficiency and reduces costs of single transportation. In addition, when the massage head 3 is damaged, a user can easily remove the massage head 3 from the mounting seat 2 and replace the massage head with a new one without replacing an entire device, which is economical and convenient.

Referring to FIGS. 1 to 6, the second positioning hole 212 includes a first hole slot 2221 and a second hole slot 2222. The first hole slot 2221 is provided at one end of the mounting seat 2, and the second hole slot 2222 is provided in the first hole slot 2221 and penetrates to the other end of the mounting seat 2. The second hole slot 2222 has a diameter less than that of the first hole slot 2221.

In the above embodiment, the first hole slot 2221 is provided at one end of the mounting seat 2, and has a relatively large dimension as a main positioning area, which facilitates preliminary positioning and alignment with the sliding rod 1 or other connecting members. The second hole slot 2222 is provided in the first hole slot 2221 and penetrates to the other end of the mounting seat 2, to form a nested structure. Importantly, the second hole slot 2222 has a diameter less than that of the first hole slot 2221. In this design, a positioning pin or a fastener can be first preliminarily positioned through the first hole slot 2221 when inserted, and then more tightly locked when pushed into the second hole slot 2222.

Referring to FIGS. 1 to 6, the buckle 23 includes a buckle body 231 and a connecting rod 232. One end of the connecting rod 232 is fixedly arranged on the massage head 3. The buckle body 231 is a cone, and a bottom surface of the buckle body 231 is fixedly connected to the other end of the connecting rod 232.

In the above embodiment, one end of the connecting rod 232 is firmly fixed to the massage head 3 as a connecting bridge between the buckle 23 and the massage head 3, which ensures that the buckle 23 can move or be positioned with the massage head 3. The buckle body 231 is designed in a conical shape. This shape not only facilitates rapid alignment with a corresponding clamping groove or interface, but also can facilitate insertion of the buckle 23, and the buckle 23 has a relatively large bottom area after being inserted.

Referring to FIGS. 1 to 6, an edge of the mounting seat 2 is further provided with a circle of limiting edge 24, and the limiting edge 24 protrudes relative to a plane of the mounting seat 2. The massage head 3 is further provided with a limiting portion 31, and the limiting portion 31 fits with the limiting edge 24.

In the above embodiment, a main structural principle of the limiting edge 24 designed at the edge of the mounting seat 2 is to provide a physical barrier to limit a relative position of the massage head 3. The limiting edge 24 protrudes relative to the plane of the mounting seat 2, forming a clear boundary to ensure that the massage head 3 does not exceed a predetermined range during mounting. In addition, the limiting portion 31 on the massage head 3 matches the limiting edge 24 in shape and dimension, so that when the massage head 3 is placed on the mounting seat 2, the limiting portion 31 can accurately fit with the limiting edge 24. In this design, not only the stability of the massage head 3 on the mounting seat 2 is enhanced, but also the massage head 3 is prevented from shifting in a physical contact manner during use.

Referring to FIGS. 1 to 6, the sliding rod 1 is further provided with a wire hole 13.

In the above embodiment, requirements for line layout and transmission are met.

Referring to FIGS. 1 to 6, the buckle 23 is made of an elastic material.

In the above embodiment, when the buckle 23 matches the buckling hole 22 in the mounting seat 2, an elastic portion of the buckle 23 is compressed and deformed, then crosses an edge of the buckling hole 22 and then is quickly restored to an original shape, so as to be tightly clamped in the buckling hole 22.

Referring to FIGS. 1 to 6, the mounting seat 2 is provided with a Velcro hook side, and the massage head 3 is provided with a Velcro loop side.

In the above embodiment, the mounting seat 2 can be connected to the massage head 3 more stably.

The above descriptions are only preferred embodiments of the present disclosure, and are not intended to limit the present disclosure in any form. Although the present disclosure has been disclosed by the preferred embodiments above, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification and equivalent change made to the foregoing embodiments according to the technical essence of the present disclosure without departing from the content of the technical solution of the present disclosure shall fall within the scope of the technical solution of the present disclosure.

What is claimed is:

1. A mounting structure capable of adapting to multiple massage heads, comprising a sliding rod and a mounting seat, wherein a center of the sliding rod is a hollow limiting groove, an edge end of the sliding rod is provided with a first positioning hole, a limiting member abutting against an edge of the limiting groove is arranged at a center of the mounting seat, the limiting member is provided with a second positioning hole, a limiting column adapted to the limiting groove is arranged at a center of the limiting member, the mounting seat is further provided with a plurality of buckling holes, and the massage head is provided with buckles with the same number as that of the buckling holes.

2. The mounting structure capable of adapting to multiple massage heads according to claim 1, wherein the second positioning hole comprises a first hole slot and a second hole slot, the first hole slot is provided at one end of the mounting seat, the second hole slot is provided in the first hole slot and penetrates to the other end of the mounting seat, and the second hole slot has a diameter less than that of the first hole slot.

3. The mounting structure capable of adapting to multiple massage heads according to claim 1, wherein the buckle comprises a buckle body and a connecting rod, one end of the connecting rod is fixedly arranged on the massage head, the buckle body is a cone, and a bottom surface of the buckle body is fixedly connected to the other end of the connecting rod.

4. The mounting structure capable of adapting to multiple massage heads according to claim 1, wherein an edge of the mounting seat is further provided with a circle of limiting edge, and the limiting edge protrudes relative to a plane of the mounting seat.

5. The mounting structure capable of adapting to multiple massage heads according to claim 4, wherein the massage head is further provided with a limiting portion, and the limiting portion fits with the limiting edge.

6. The mounting structure capable of adapting to multiple massage heads according to claim 1, wherein the sliding rod is further provided with a wire hole.

7. The mounting structure capable of adapting to multiple massage heads according to claim 1, wherein the buckle is made of an elastic material.

8. The mounting structure capable of adapting to multiple massage heads according to claim 1, wherein the mounting seat is provided with a Velcro hook side, and the massage head is provided with a Velcro loop side.
